(19) United States
(12) Patent Application Publication
(10) Pub. No.: US 2016/0314130 A1
(43) Pub. Date: Oct. 27, 2016

(54) COMPUTING DEVICE WITH SPELL-CHECK FEATURE

(71) Applicant: Tribune Broadcasting Company, LLC, Chicago, IL (US)

(72) Inventor: Gary Wilson Cox, Sacramento, CA (US)

(21) Appl. No.: 14/696,117

(22) Filed: Apr. 24, 2015

(51) Int. Cl. G06F 17/30; G06F 17/24; G11B 27/036; G06F 17/27

(52) U.S. Cl. CPC G06F 17/3064; G06F 17/30867; G06F 17/273; G06F 17/24; G11B 27/036

(57) ABSTRACT

In one aspect, an example method includes receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and responsive to determining that the search engine has suggested the second search-phrase based on the query, modifying, by the computing device, an electronic report by adding the first text to the electronic report.

### USAGE AND TERMINOLOGY

Throughout this application, with respect to all reasonable derivatives of such terms, and unless otherwise specified (and/or unless the particular context clearly dictates otherwise), each usage of “a” or “an” means at least one, and each usage of “the” means the at least one.

### BACKGROUND

Unless otherwise indicated herein, the materials described in this section are not prior art to the claims in this disclosure and are not admitted to be prior art by inclusion in this section.

A media organization may provide consumers with various types of information. For example, in the time leading up to an election of a candidate for political office, the media organization may provide consumers with information related to various candidates, the progress of election campaigns, results of the election, and other information related to the election. In order to provide this information, a media organization may use an election system to gather, organize, and output the information.

For a variety of reasons, such as to establish credibility with consumers, a media organization may seek to ensure that the information it provides is accurate. For example, in the context of an upcoming election, the media organization may seek to ensure that it is providing consumers with accurate information about potential candidates.

### SUMMARY

In a first aspect, an example method includes receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and, responsive to determining that the search engine has suggested the second search-phrase based on the query, modifying, by the computing device, an electronic report by adding the first text to the electronic report.

In a second aspect, an example method includes receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and, responsive to determining that the search engine has suggested the second search-phrase based on the query, outputting, by the computing device via a user interface, a prompt requesting a command to modify the first text by replacing the first text with the second text.

In a third aspect, an example method includes receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and, responsive to determining that the search engine has suggested the second search-phrase based on the query, performing, by the computing device, an action.

In a fourth aspect, an example non-transitory computer-readable medium has stored thereon program instructions that when executed cause a computing device to perform a set of acts including receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and, responsive to determining that the search engine has suggested the second search-phrase based on the query, modifying, by the computing device, an electronic report by adding the first text to the electronic report.

In a fifth aspect, an example non-transitory computer-readable medium has stored thereon program instructions that when executed cause a computing device to perform a set of acts including receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and, responsive to determining that the search engine has suggested the second search-phrase based on the query, outputting, by the computing device via a user interface, a prompt requesting a command to modify the first text by replacing the first text with the second text.

In a sixth aspect, an example non-transitory computer-readable medium has stored thereon program instructions that when executed cause a computing device to perform a set of acts including receiving, by a computing device, first data representing first text; querying, by the computing device, a search engine using a first search-phrase, wherein the first search-phrase includes the represented first text; determining, by the computing device, that the search engine has suggested a second search-phrase based on the query, wherein the second search-phrase includes second text and is different from the first search-phrase; and, responsive to determining that the search engine has suggested the second search-phrase based on the query, performing, by the computing device, an action.

### BRIEF DESCRIPTION OF THE DRAWINGS

FIG. 1 is a simplified block diagram illustrating an example system.

FIG. 2 is a simplified block diagram illustrating an example computing device.

FIG. 3 is a schematic diagram illustrating an example query and search result.

FIG. 4 is a schematic diagram illustrating another example query and search result.

FIG. 5 is a flow chart illustrating an example method.

FIG. 6 is a flow chart illustrating another example method.

FIG. 7 is a flow chart illustrating yet another example method.

### DETAILED DESCRIPTION

I. Overview

As noted above, a media organization may seek to provide accurate information to consumers. In the context of an election, the media organization may use an election system to gather and organize information before providing it to consumers. In one example, a human may input information, such as a candidate's name, into the election system. In some cases, the human entering the information may make a typographical error, which if not caught, may be disseminated to consumers.

One approach to identifying and correcting such a typographical error may involve using a computer-implemented spell-checker. However, such a spell-checker may use a standard dictionary, which may not include certain terms intended to be input into the election system. For example, a standard spell-check dictionary may not include a candidate's name. In other examples, a standard spell-check dictionary may include common names and variations thereof, but the spell-checker may not be able to determine which variation is correct in a given instance.

An alternative approach is to leverage a search engine to identify and facilitate correcting such a typographical error. In general, search engines work by crawling the web to obtain information, indexing the information, and then searching the indexed information based on a query that includes a search phrase. This may allow a search engine to quickly return search results based on the query.

In addition, a search engine may include a feature of using a first search-phrase to suggest an alternative, second search-phrase, such as when the first search-phrase has a typographical error, for example. The search engine may use an algorithm to determine such a suggestion based on popularity, relevance, location, or other criteria.

In leveraging a search engine to identify and facilitate correcting a typographical or other type of error, an example method may include receiving, by a computing device, first data representing first text. The first text may include a misspelled name of a candidate for political office. The method may also include querying, by the computing device, a search engine using a first search-phrase, wherein the first search-phrase includes the represented first text. The method may also include determining, by the computing device, that the search engine has suggested a second search-phrase based on the query, wherein the second search-phrase includes second text and is different from the first search-phrase. For instance, the second search-phrase may include the correctly spelled name of the candidate. The example method may also include, responsive to determining that the search engine has suggested the second search-phrase based on the query, performing, by the computing device, an action.

In some examples, the action may include outputting via a user interface, a prompt requesting a command to modify the first text by replacing the first text with the second text (e.g., a command to replace the misspelled name with the correctly spelled name). In other examples, the action may include modifying an electronic report by adding the first text to the electronic report for later processing and/or review. In still other examples, the action may include modifying data representing the first text such that the modified first data represents the second text in place of the first text.

In some examples, the method may further include retrieving, by the computing device, second data representing third text that corresponds to the first text, wherein the first search-phrase further includes the represented third text. In one example, the first text may include the name of a candidate for a political office corresponding to a government, and the third text may include the political office and/or the corresponding government. As such, the computing device may query the search engine using a search-phrase that includes the name, the political office, and/or the government.

In still further examples, the method may include receiving, by the computing device, a search result of the query, and the act of determining, by the computing device, that the search engine has suggested the second search-phrase based on the query may involve identifying, by the computing device, an indicator phrase within the received search result. In one example, the indicator phrase may include text such as “did you mean,” “including results for,” or “displaying results for,” among other phrases. The indicator phrase may be used to determine that a second search-phrase has been suggested.

In an example where the computing device modifies the electronic report by adding the first text to the electronic report, the method may also include outputting, by the computing device, the electronic report via a user interface. Also, in some instances, the act of modifying the electronic report may involve adding the second text to the electronic report.

In still other examples, the method may include receiving a video stream, modifying the received video stream by overlaying the second text on the received video stream, and transmitting the modified video stream to a receiver.

II. Example System

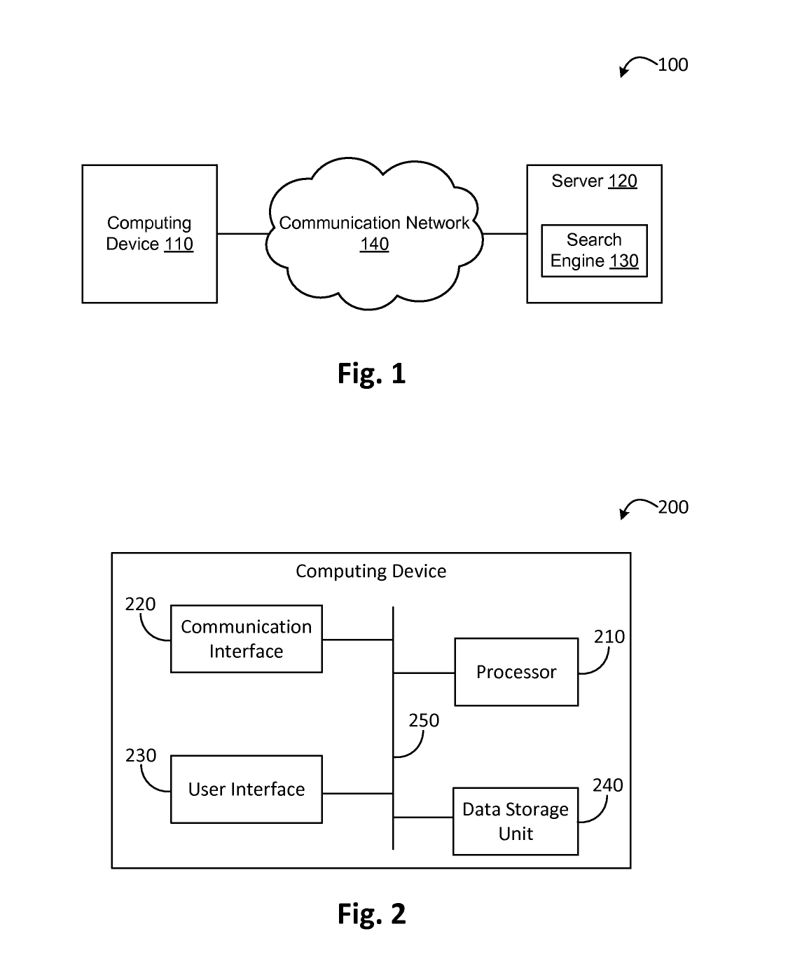

FIG. 1 is a simplified block diagram illustrating an example system 100. The system 100 may include a computing device 110, a server 120, and a communication network 140. The server 120 may include search engine 130.

Computing device 110 may include components such as one or more communication interfaces, processors, user interfaces, and/or data storage units. In some examples computing device 110 may be implemented as computing device 200, discussed in more detail below.

Computing device 110 in system 100 may be configured to carry out one or more acts of methods 500, 600, and 700, discussed in further detail below. For example, computing device 110 may be configured to receive first data representing first text. The first data may be received via a communication interface, a user interface, or via another interface for receiving data. In some examples, the first text may include the name of a candidate for political office. In other examples, the first text may include a title or political office such as Congressman, Congresswoman, Governor, or Judge, for example.

Computing device 110 may also be configured to query a search engine, such as search engine 130, for example. The query may include a first search-phrase, which may include the represented first text. The first search-phrase may also include Boolean symbols, Boolean terms, and/or other text in addition to the represented first text. In some examples, the query may also include metadata or information specific to computing device 110 or the search engine being queried by computing device 110. For instance, the query may include location information, which may allow the search engine to return more accurate and/or relevant results.

In some examples, the computing device 110 and search engine 130 (and/or server 120) may communicate via communication network 140. Communication network 140 may include a wired or wireless connection, such as an Ethernet connection, Universal Serial Bus (USB) connection, twisted pair wire, coaxial cable, fiber-optic link, Bluetooth connection, Wi-Fi, WiMAX, or wireless wide-area network (WWAN) connections for example. Computing device 110 and search engine 130 (and/or server 120) may communicate via one or more communication paths that traverse communication network 140.

Server 120 in the system 100 may include search engine 130, and may be configured to communicate with computing device 110 via communication network 140. In some examples, server 120 may be implemented as a computing device, such as computing device 200.

Search engine 130 in the server 120 may be configured to receive a query from computing device 110. Search engine 130 may then be configured to process the query, which may include searching a database based on the received query. In some examples, search engine 130 may transmit, return, or otherwise notify computing device 110 of the results of processing the query. In one example, search engine 130 may receive a query including a first search-phrase, and then suggest a second search-phrase that is different from the first search-phrase. This may occur when the first search-phrase has a typographical error, for example. The search engine may transmit the suggested second search-phrase to the computing device via communication network 140.

Computing device 110 may also be configured to determine that search engine 130 has suggested a second search-phrase based on the query. In some examples, determining that the second search-phrase has been suggested may be performed by computing device 110 identifying specific text within a received search result that indicates a second search-phrase has been suggested. For instance, computing device 110 may identify text such as “did you mean,” or “displaying results for,” for example. Other phrases and text are possible as well. In other examples, computing device 110 may determine that the second search-phrase has been suggested based on a received signal, data, metadata, indicator, or other information received from search engine 130 and/or server 120. For instance, search engine 130 and/or server 120 may transmit a signal, responsive to a query, indicating that the received query contains a possible misspelling or error. As such, computing device 110 may receive the signal, and determine that a second search-phrase has been suggested.

Computing device 110 may further be configured to perform an action responsive to determining that the search engine has suggested the second search-phrase based on the query. In some examples, the action may include outputting, by computing device 110 via a user interface, a prompt requesting a command to modify the first text by replacing the first text with the second text. In other examples, the action may include computing device 110 modifying an electronic report by adding the first text to the electronic report for later processing and/or review. In still other examples, the action may include computing device 110 modifying data representing the first text such that the modified first data represents the second text in place of the first text.

III. Example Computing Device

FIG. 2 is a simplified block diagram illustrating an example computing device 200. Computing device 200 may represent computing device 110, and/or server 120, for example. Computing device 200 may be configured for performing a variety of functions or acts, such as those described in this disclosure (including the accompanying drawings). Computing device 200 may include various components, including for example, one or more processors 210, one or more communication interfaces 220, one or more user interfaces 230, and one or more data storage units 240. The components of computing device 200 may be communicatively connected to each other (or other devices or systems) via a system bus, network, or other connection mechanism 250.

Processor 210 in computing device 200 may include one or more general purpose processors, central processing units (CPUs), CPU cores, and/or one or more special purpose processors (e.g., graphics processing units (GPUs), digital signal processors (DSPs), field programmable gated arrays (FPGAs), or application specific integrated circuits (ASICs)). Processor 210 may be configured to execute computer-readable program instructions contained in data storage unit 240, and/or other instructions as described herein.

Communication interface 220 may be configured to allow computing device 200 to communicate with one or more devices (or systems) according to one or more protocols. In one example, communication interface 220 may be a wired interface, such as an Ethernet interface or a USB interface. As another example, communication interface 220 may be a wireless interface, such as a cellular or Wi-Fi interface, for example. Other example communication interfaces may include an Ethernet interface, Universal Serial Bus (USB) interface, fiber-optic link, coaxial cable, Bluetooth, ZigBee, WiMAX, wireless wide-area network (WWAN), and/or other similar type of interface.

User interface 230 may facilitate interaction with a user of computing device 200, if applicable. As such, user interface 230 may include input components such as a keyboard, keypad, computer mouse, trackball, joystick, camera, microphone, voice recognition module, and touch sensitive panel, and output components such as a display screen (which, for example, may be combined with a touch sensitive panel), sound speaker, and haptic feedback system.

Data storage unit 240 may include one or more volatile, non-volatile, removable, and/or non-removable storage components, such as magnetic, optical, or flash storage, and may be integrated in whole or in part with processor 210. Further, data storage unit 240 may take the form of a non-transitory computer-readable storage medium, having stored thereon program instructions (e.g., compiled or non-compiled program logic and/or machine code) that, when executed by processor 210, cause computing device 200 to perform one or more functions or acts, such as those described in this disclosure. Such program instructions may define or be part of a discrete software application that can be executed in response to certain inputs received from user interface 230, for instance. Data storage unit 240 may also store other types of information or data, such as those types described throughout this disclosure.

IV. Example Queries and Search Results

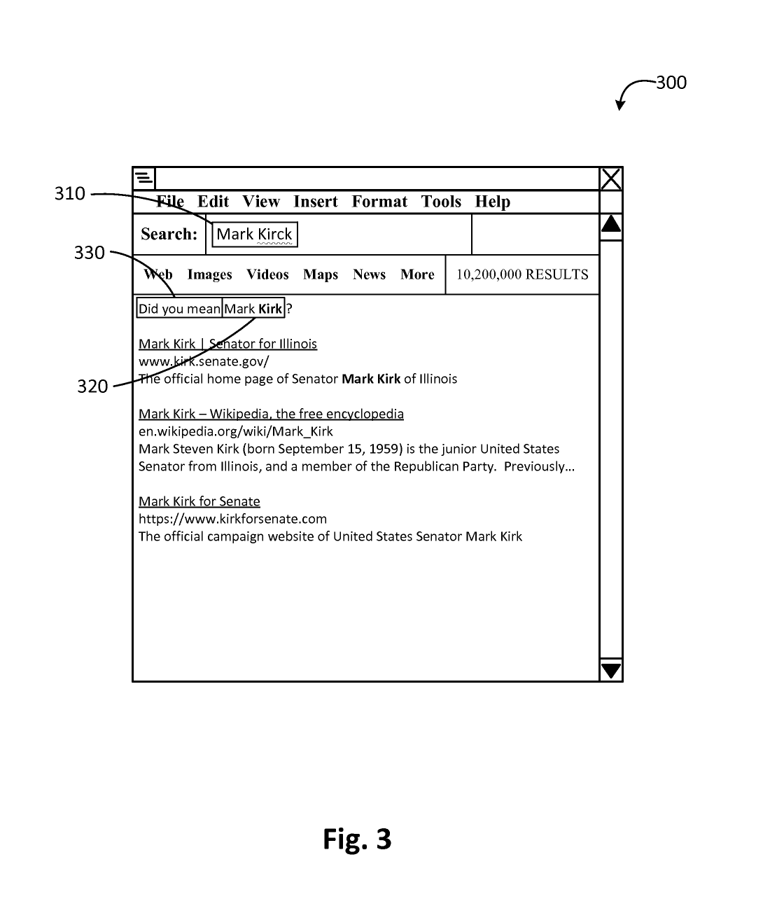

FIG. 3 is a schematic diagram illustrating an example query and search result. Diagram 300 shows a first search-phrase 310, a suggested second search-phrase 320, and an indicator phrase 330.

In the example shown in FIG. 3, first search-phrase 310 includes first text “Mark Kirck.” In other examples, first search-phrase 310 may include other names, identifiers and/or text. First search-phrase 310 may be transmitted to a search engine as part of a query. The search engine may then process the query, and/or suggest a second search-phrase 320. In the example shown in FIG. 3, the suggested second search-phrase 320 includes second text “Mark Kirk.” Second search-phrase 320 may be different from first search-phrase 310, and in some examples may include second text that is a correct spelling of incorrectly spelled first text included in the first search-phrase. In other examples, suggested second search-phrase may include an alternate spelling of first text included in the first search-phrase. In still other examples, suggested second search-phrase 320 may include second text that is related to the first text included in the first search-phrase, which may help the search engine determine a suggested second search-phrase.

Diagram 300 also includes indicator phrase 330. Indicator phrase 330 may be used by a computing device to determine that the search engine has suggested second search-phrase 320. In the example shown in FIG. 3, indicator phrase 330 includes the text “did you mean.” In some examples, the search engine may include an indicator phrase in the search results to indicate that the first search-phrase may have included an error. In other examples, indicator phrase 330 may include the text “including results for,” “displaying results for,” or “showing results for,” for example. Other indicator phrases are possible as well.

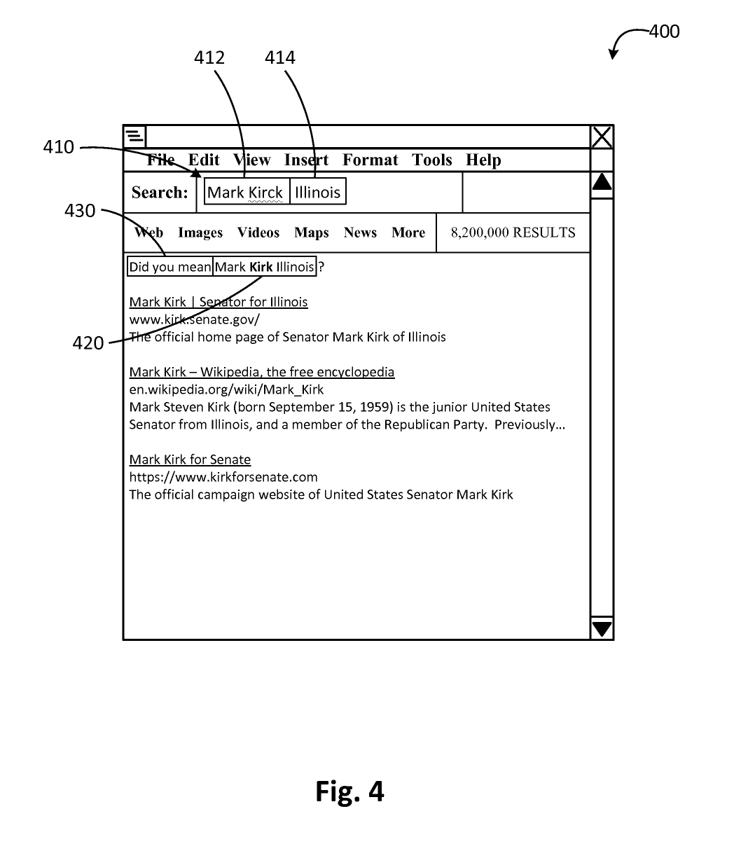

FIG. 4 is a schematic diagram illustrating another example query and search result. Diagram 400 shows first search-phrase 410, suggested second search-phrase 420, and indicator phrase 430. One or more features shown in diagram 400 may be similar or identical to one or more features shown in diagram 300.

First search-phrase 410 in diagram 400 may include first text 412 and third text 414. For clarification, “second text” corresponds to text included in the second search-phrase suggested by the search engine. First text 412 may include a name of a candidate for political office, a title, or other text used to identify a person. In the example shown by diagram 400, first text 412 includes the text “Mark Kirck.”

Third text 414 may include text corresponding to the first text. For example, third text 414 may include the U.S. State of the political office held by a person identified by the first text 412. In other examples, third text 414 may include the political office being sought by a person identified by first text 412, such as a political office currently at issue in an election. As a specific example, third text 414 shown in diagram 400 includes the text “Illinois,” which corresponds to the U.S. State of the political office held by Senator Mark Kirk. In still other examples, third text 414 may include a date, a location such as a town, city, or state, or other text that corresponds to a person identified by first text 412.

In some examples, a computing device may retrieve third text 414 from a data storage unit. As an example, a computing device may include a database in a data storage unit that includes text, such as names, locations, party affiliations, job titles, and other information of candidates for political office. A computing device may receive first data representing first text (e.g., a name), and based on the first text, retrieve corresponding third text from the database (e.g., a political office corresponding to the name). Other storage structures and text are possible as well.

In other examples, a computing device may receive third text 414 via a user interface or communication interface.

The computing device may then query a search engine using the first search-phrase 410, which may include both the first text 412 and the third text 414. In response, the search engine may suggest a second search-phrase 420 based on the first search-phrase 410, wherein the second search-phrase includes second text. As shown, the suggested second search-phrase 420 includes the second text “Mark Kirk Illinois”. In some examples, the search engine may also include indicator phrase 430 in the results. The computing device may then determine that the search engine has suggested the second search-phrase 420.

V. Example Operations

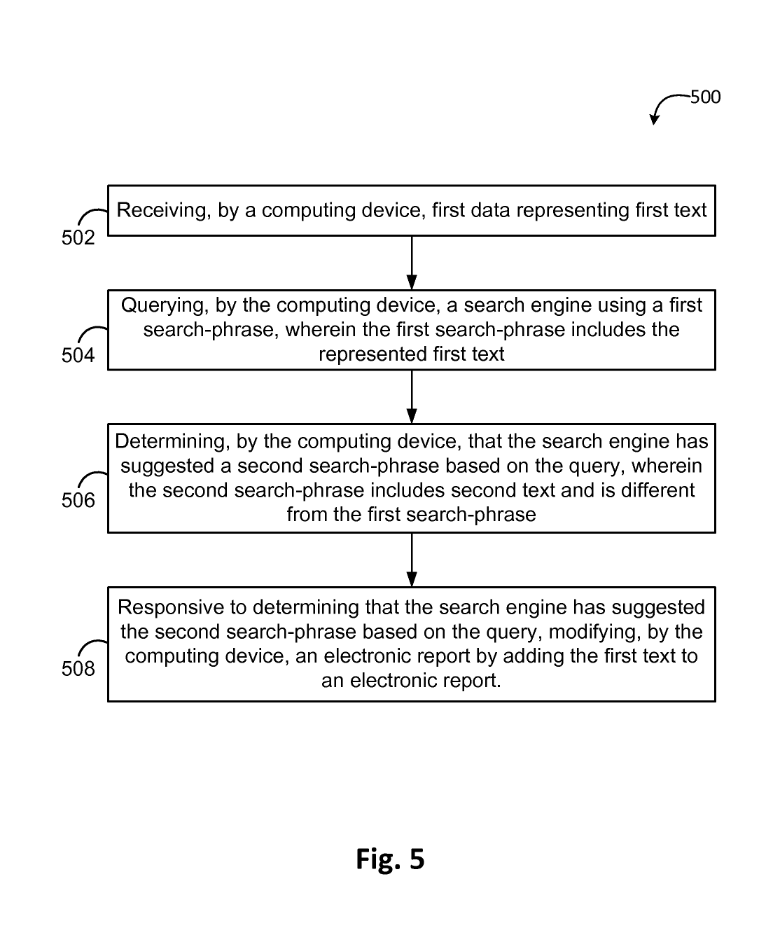

FIG. 5 is a flow chart illustrating an example method 500. At block 502, method 500 may include receiving, by a computing device, first data representing first text. The act at block 502 may include the computing device receiving first data via a user interface, such as from a keyboard, for example. Alternatively, the computing device may receive the first data via a communications interface from a device or system connected to the computing device.

In some examples, the computing device may also receive or retrieve second data. The second data may represent third text that corresponds to the first text (e.g., a U.S. State of a political office corresponding to the name of a candidate for that political office). In some cases, the computing device may include a data storage unit, and the second data may be included in the data storage. In other examples, the second data may be received from a user interface or network interface of the computing device. For instance, the computing device may be connected to one or more other systems or devices, one or more of which may include the second data.

At block 504, method 500 may include querying, by the computing device, a search engine using a first search-phrase, wherein the first search-phrase includes the represented first text. In some examples, the first search-phrase may also contain the third text (represented by the second data). As such, an example first search phrase may include both a name of a candidate for a political office and the U.S. State corresponding to the political office.

Querying the search engine may include sending a command to the search engine to perform a search using the first search-phrase. In some examples, the command may be transmitted via a communication interface. Querying the search engine may also include transmitting metadata or information in addition to the first search-phrase. The metadata or additional information may be used by the search engine in performing the search. For instance, metadata may include location information of the computing device transmitting the query. The search engine may use the location information to narrow down or provide a more accurate search result and/or suggested second search-phrase.

As a specific example, a first search-phrase may include first text “John Smth Mayor.” There may be two mayoral elections in two different cities, where the candidates' names are “John Smyth” and “John Smith” respectively. A search engine receiving the query may not be able to determine whether Smyth or Smith should be suggested as the second search-phrase without additional information. However, location information, metadata, or other information transmitted along with the first search-phrase may be used by the search engine to narrow the results. The search engine may then be able to suggest a second search-phrase corresponding to the name of the candidate most closely located physically to the computing device (i.e., based on the city in which the computing device is located).

At block 506, method 500 may include determining, by the computing device, that the search engine has suggested a second search-phrase based on the query, wherein the second search-phrase includes second text and is different from the first search-phrase. In some examples, the determination may be based on search results received from the search engine. For instance, where the search results include an indicator phrase such as “did you mean” or similar text, the computing device may determine that a second search-phrase has been suggested. In other examples, the determination may be based on text, metadata, signals, or information included in the search results. For instance, where the search engine suggests a second search-phrase, the search engine may transmit a notification signal to the computing device. The notification signal may alert the computing device that an error or mistake was included in the first search-phrase.

At block 508, method 500 may include, responsive to determining that the search engine has suggested the second search-phrase based on the query, modifying, by the computing device, an electronic report by adding the first text to the electronic report. In some examples, the electronic report may include a list of text and/or search phrases that require further review and/or processing. For instance, the electronic report may include a work-queue, which may allow a user to review and process text and/or search phrases one at a time. The electronic report may be useful especially where many queries are transmitted to a search engine in a short span of time. A user may use the electronic report to quickly review the text and/or search-phrases to determine whether there are any errors or mistakes. A user may also use the electronic report to cause a computing device to modify the data representing the first text by replacing the first text with the second text.

In some examples, method 500 may further include outputting the electronic report via a user interface. The user interface may include a display screen, such as a liquid crystal display (LCD) or cathode ray tube (CRT), for example. Outputting the electronic report may include displaying the first text and/or search-phrase on the display screen. In some examples, the second text and/or search-phrase may also be displayed on the display screen. Other techniques for outputting the electronic report are possible as well, such as via an audio output, for example.

In still further examples, method 500 may include receiving a video stream, modifying the received video stream by overlaying the second text on the received video stream, and transmitting the modified video stream to a receiver. The computing device may receive a video stream from a device or system connected to the computing device, or may retrieve the video stream from a data storage unit. In some examples, the computing device may then overlay the second text on a portion of the video stream to create a modified video stream, such that the modified video stream includes the second text. The modified video stream may then be transmitted to a receiver for display on a display screen.

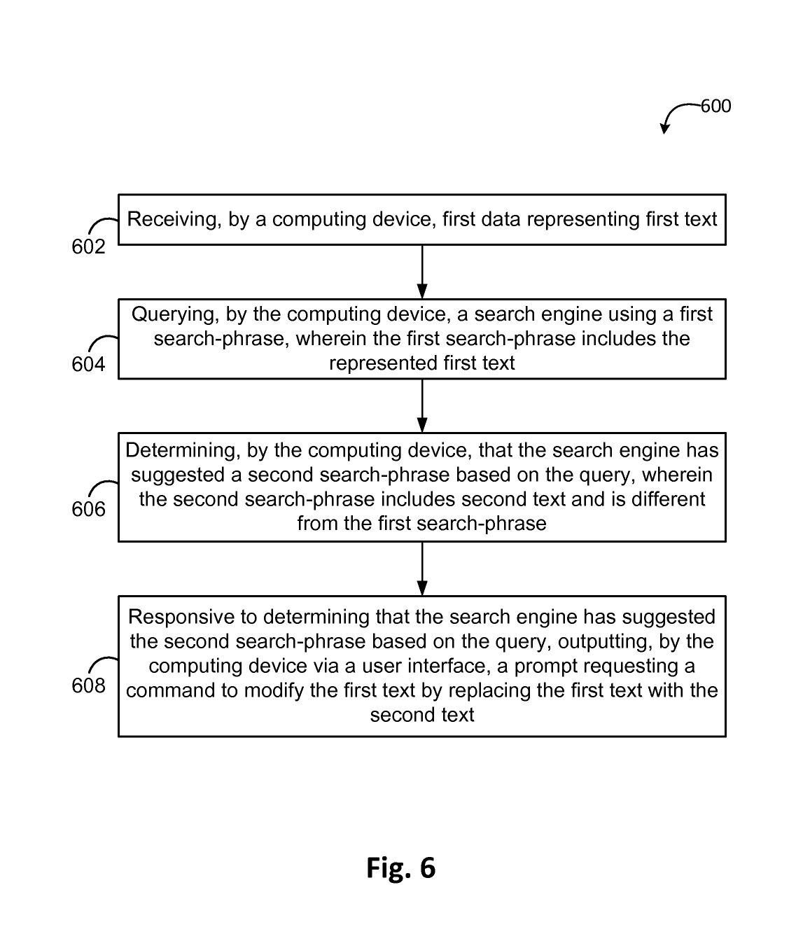

FIG. 6 is a flow chart illustrating another example method 600. One or more blocks of method 600 may be similar or identical to one or more blocks of method 500. For example, blocks 602, 604, and 606 may correspond to blocks 502, 504, and 506, respectively. Method 600 may include additional block 608.

At block 608, method 600 may include, responsive to determining that the search engine has suggested the second search-phrase based on the query, outputting, by the computing device via a user interface, a prompt requesting a command to modify the first text by replacing the first text with the second text. In some examples, the computing device may output the prompt via a user interface, such as a display screen, for example. The prompt may include the first text, first search-phrase, second text, second search-phrase, additional text or information, or any combination thereof. In some examples the prompt may request a command to replace the first text with the second text.

Method 600 may further include receiving the command to modify the first text by replacing the first text with the second text. In some examples, when the command is received by the computing device, the computing device may responsively modify the first data such that the modified first data represents the second text in place of the first text.

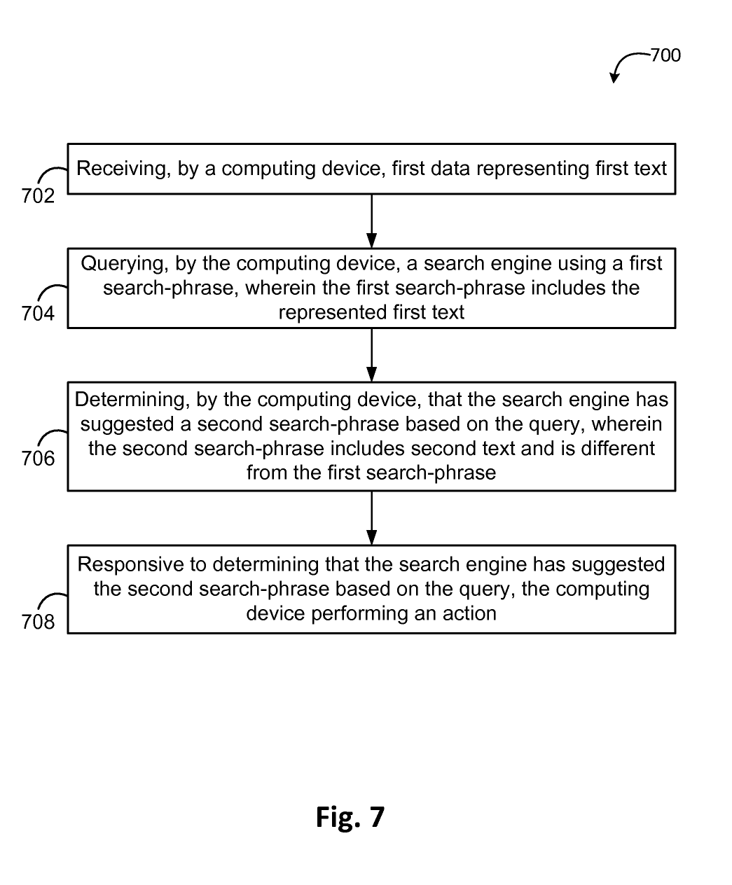

FIG. 7 is a flow chart illustrating yet another example method 700. One or more blocks of method 700 may be similar or identical to one or more blocks of methods 500 and/or 600. For example, blocks 702, 704, and 706 may correspond to blocks 502, 504, and 506, respectably or to blocks 602, 604, and 606, respectively. Method 700 may include additional block 708.

At block 708, method 700 may include, responsive to determining that the search engine has suggested the second search-phrase based on the query, the computing device performing an action. In some examples, the action may be any action herein disclosed, in particular the actions referred to in blocks 508 and 608. In other examples, the action may include the computing device modifying data representing the first text such that the modified first data represents the second text in place of the first text. In other examples the action may include transmitting a notification to one or more devices or systems, modifying a received video stream, or causing a predetermined set of instructions to be executed by a processor in the computing device. Other actions are possible as well.

VI. Example Variations

While one or more acts or features have been described as being performed by certain devices, systems, or entities (e.g., computing device 110 and/or 200), the acts or features may be performed by any device, system, or entity, such as those described in connection with the system 100. Furthermore, the devices and systems need not be discrete entities. Some or all of the devices or systems may be combined in a single device, and/or may share one or more components such as a processor or data storage, for example.

In addition, the acts described herein need not be performed in the disclosed order, although in some examples and order may be preferred. Also, not all acts need to be performed to achieve the desired advantages of the disclosed systems, devices, and methods, and therefore not all acts are required. Variations discussed in connection with one example may be applied to all other examples disclosed herein.

While select examples of the present disclosure have been described, alterations and permutations of these examples will be apparent to those of ordinary skill in the art. Other changes, substitutions, and alterations are also possible without departing from the invention on its broader aspects as set forth in the following claims.

What is claimed is:

1. A method comprising:
receiving, by a computing device, first data representing first text;
querying, by the computing device, a search engine using a first search-phrase, wherein the first search-phrase includes the represented first text;
determining, by the computing device, that the search engine has suggested a second search-phrase based on the query, wherein the second search-phrase includes second text and is different from the first search-phrase; and
responsive to determining that the search engine has suggested the second search-phrase based on the query, modifying, by the computing device, an electronic report by adding the first text to the electronic report.

2. The method of claim 1, further comprising:
retrieving, by the computing device, second data representing third text that corresponds to the first text; and
wherein the first search-phrase further includes the represented third text.

3. The method of claim 2, wherein the first text comprises a name of a candidate for a political office corresponding to a government, and the third text comprises at least one of the political office and the government.

4. The method of claim 1, further comprising:
receiving, by the computing device, a search result of the query; and
wherein determining, by the computing device, that the search engine has suggested the second search-phrase based on the query comprises identifying, by the computing device, an indicator phrase within the received search result.

5. The method of claim 1, further comprising:
outputting, by the computing device via a user interface, the modified electronic report.

6. The method of claim 5, wherein modifying, by the computing device via the user interface, the electronic report, comprises adding to the electronic report, the second text.

7. The method of claim 1, wherein outputting, by the computing device via the user interface, the modified electronic report, comprises displaying, by the computing device via the user interface, the modified electronic report.

8. The method of claim 1, further comprising:
receiving a video stream;
modifying the received video stream by overlaying the second text on the received video stream; and
transmitting the modified video stream to a receiver.

9. A method comprising:
receiving, by a computing device, first data representing first text;
querying, by the computing device, a search engine using a first search-phrase, wherein the first search-phrase includes the represented first text;
determining, by the computing device, that the search engine has suggested a second search-phrase based on the query, wherein the second search-phrase includes second text and is different from the first search-phrase; and
responsive to determining that the search engine has suggested the second search-phrase based on the query, outputting, by the computing device via a user interface, a prompt requesting a command to modify the first text by replacing the first text with the second text.

10. The method of claim 9, further comprising:
retrieving, by the computing device, second data representing third text that corresponds to the first text, wherein the first search-phrase further includes the represented third text.

11. The method of claim 10, wherein the first text comprises a name of a candidate for a political office corresponding to a government, and the third text comprises at least one of the political office and the government.

12. The method of claim 9, further comprising:
receiving, by the computing device, a search result of the query; and
wherein determining, by the computing device, that the search engine has suggested the second search-phrase based on the query comprises identifying, by the computing device, an indicator phrase within the received search result.

13. The method of claim 9, further comprising:
receiving, by the computing device via the user interface, the command;
responsive to receiving, by the computing device via the user interface, the command, modifying, by the computing device, the first data such that the modified first data represents the second text in place of the first text.

14. A method comprising:
receiving, by a computing device, first data representing first text;
querying, by the computing device, a search engine using a first search-phrase, wherein the first search-phrase includes the represented first text;
determining, by the computing device, that the search engine has suggested a second search-phrase based on the query, wherein the second search-phrase includes second text and is different from the first search-phrase; and
responsive to determining that the search engine has suggested the second search-phrase based on the query, performing, by the computing device, an action.

15. The method of claim 14, further comprising:
retrieving, by the computing device, data representing third text that corresponds to the first text; and
wherein the first search-phrase further includes the represented third text.

16. The method of claim 14, further comprising:
receiving, by the computing device, a search result of the query; and
wherein determining, by the computing device, that the search engine has suggested the second search-phrase based on the query comprises identifying, by the computing device, an indicator phrase within the received search result.

17. The method of claim 14, wherein performing, by the computing device, the action, comprises modifying, by the computing device, the first data such that the modified first data represents the second text in place of the first text.

18. The method of claim 17, further comprising:
receiving a video stream;
modifying the received video stream by overlaying the second text on the received video stream; and
transmitting the modified video stream to a receiver.

19. The method of claim 14, wherein performing, by the computing device, the action comprises modifying, by the computing device, an electronic report by adding the first search-phrase to the electronic report.

20. The method of claim 14, wherein performing, by the computing device, the action comprises outputting, by the computing device via a user interface, a prompt requesting a command to modify the first text by replacing the first text with the second text.
